(19) United States
(12) Patent Application Publication
(10) Pub. No.: US 2004/0249832 A1
(43) Pub. Date: Dec. 9, 2004

(54) Method for systemic enterprise knowledge management

(76) Inventor: Ward Hillary Goldthorpe, Eaglemont (AU)

Correspondence Address: Ward H. Goldthorpe, 35 Glenard Drive, Eaglemont Victoria, 3084, AU

(21) Appl. No.: 10/475,622

(22) PCT Filed: Jan. 4, 2002
(86) PCT No.: PCT/AU02/00006

(51) Int. Cl. G06F 17/00

(52) U.S. Cl. 707/100

(57) ABSTRACT

The present invention is a method, system, and computer program product for performing systemic knowledge management in an enterprise using a computer network. A universal framework that defines the structure and representation of processes, knowledge, and knowledge interrelationships between processes in an enterprise is created. The framework is used for dynamically building a model of the enterprise in real time, said model representing the enterprise as an evolving system of interconnected processes and knowledge domains. The model is stored on an enterprise knowledge database and made available over the computer network so that it may be utilised in real time by either members of the enterprise as network users, or computer applications, for managing execution of processes, and managing knowledge about and contained within processes and systems of processes.

### TECHNICAL FIELD

The present invention relates to the management of knowledge about and contained within an enterprise and its processes, and more specifically to computer-assisted enterprise knowledge management methods. In particular the invention is directed to a method and system using a computer network to dynamically replicate the fundamental knowledge structure of processes, systems of processes, and knowledge interrelationships within the system of processes. The invention is also directed to facilitating knowledge worker productivity and organisational learning through the capture, use and transfer of knowledge about and contained within the system of processes constituting an enterprise.

### BACKGROUND ART

Management science has recognised for some time the importance of organisational learning for enterprise value creation, performance improvement and optimisation. Organisational learning can be thought of as collective learning that transforms knowledge created within an enterprise into collective knowledge and experience that can be used and acted upon by the entire enterprise for the benefit of the enterprise. The objectives of Knowledge Management as an art, and of computer systems that support and facilitate Knowledge Management, ultimately are to enhance knowledge worker productivity and to enable organisations to collectively learn, use and act upon knowledge in a fashion analogous to that of an individual. Paradoxically, although organisational learning depends on the collective learning of individuals within an enterprise, each individual is often unaware of the impact of their decisions or actions on the system. In his book “The Fifth Discipline—The Art and Practice of the Learning Organization”, Doubleday, New York, 1990, Peter Senge highlights the problem: “ . . . the core learning dilemma that confronts organisations: we learn from experience but we never directly experience the consequences of many of our most important decisions.” Knowledge is an active concept, not a passive one like data or information. In order for knowledge to exist and grow, there is always an action element. Chilean cognitive biologist Humberto Maturana has coined the phrase “All knowing is doing. All doing is knowing.” to emphasise this fact.

Advances in Information Technology hardware and software infrastructure (in particular the Internet, intranets and extranets) have made it possible to capture, access and use massive amounts of both enterprise and external data and information. The explosion in the volume of this data has lead to new and more powerful tools for data warehousing and mining, document management, data and software integration, and collaboration and information sharing. However, whilst this infrastructure provides all pervasive connectedness within an enterprise, and between an enterprise and its environment, it does not of itself provide solutions to the organisational learning paradox and to the essential organisational learning requirement of integrating information and action.

Leading management thinkers have identified certain key requirements for successful enterprise knowledge management and enhanced knowledge worker productivity. The first is that an enterprise has to be viewed holistically, and as a system it needs to be able to manage itself and its actions. The second is that because this system is made up of individuals, individuals must all take responsibility for knowledge management and for their own productivity. Individuals are in the best position to know what data and information they need to perform their work, and to link information to action. They have to be able to access the enterprise's information and knowledge wherever and whenever they need it. They also have to create accessibility to their own information and knowledge so that it can be transferred to others as and when they choose to make use of it. As Peter Drucker points out in his book “Management Challenges for the 21^{st} Century”, Butterworth-Heinemann, Oxford, 1999: “ . . . no one can provide the information that knowledge workers and especially executives need, except knowledge workers and executives themselves.” The third is that information and knowledge have to be organised in such a way that feedback loops are established within the system, thus allowing proactive management by all individuals of the consequences of decisions and actions within the enterprise. The fourth is that information and knowledge outside an enterprise that is imported into the enterprise must be easily integrated with inside information and knowledge in a way that reflects the existing system and its dynamics, and the context and purpose of its importation. The fifth requirement is that knowledge management has to be independent of formal organisational structure.

The state of the art in Knowledge Management does not include a universally applicable method and infrastructure meeting these requirements. There is therefore a need for a method in the art of Knowledge Management that satisfies all these requirements in a systemic and intuitive manner that can be integrated with the work and practices of managers and knowledge workers, and the tools they use.

### DISCLOSURE OF INVENTION

It is an object of the present invention to enable systemic enterprise knowledge management through a method and system using a computer network.

In the present invention, a universal framework that defines the structure and representation of processes, knowledge, and interrelationships between processes and knowledge in an enterprise is first created. The framework is used for dynamically building a model of said enterprise in real time, said model representing said enterprise as an evolving system of interconnected processes and knowledge domains. The model is stored on an enterprise knowledge database and is made available over the computer network so that either members of said enterprise as network users, or computer applications, can utilise the model in real time for managing execution of processes, and managing knowledge about and contained within processes and systems of processes.

In one aspect of the present invention, the universal framework includes core enterprise knowledge threads for representing systemic knowledge domains, an immutable universal process representation for representing the fundamental structure of all processes in an enterprise, and a knowledge association scheme for representing interrelationships between processes and knowledge in an enterprise. In another aspect of the present invention said universal framework includes a process classification scheme for classifying each process in an enterprise. In another aspect of the present invention said universal framework includes an iteration classification scheme for classifying a process when that process is repeated or restarted.

In another aspect of the present invention, a global enterprise process is created that is the ancestor of all processes initiated in the past, present and future within an enterprise. This global process is included in said model of the enterprise and provides the highest-level system view of the enterprise.

In another aspect of the present invention, the enterprise model is dynamically built in real time by either programmatically or manually adding processes to the model according to said universal framework when said processes are initiated. If a process is to be added to the model manually, a visualisation of components of said framework is displayed to a selected network user who has responsibility for adding said process.

In another aspect of the present invention utilising said model further comprises visualising and manipulating aspects of said model and using visual navigation means for navigating and searching through said model and said enterprise knowledge database.

In accordance with the present invention, there is provided a knowledge management system for enabling systemic enterprise knowledge management comprising:

a) a plurality of user computing devices connected to a computer network;

b) a server computer coupled to the computer network, said server including:

(i) memory;

(ii) storage;

(iii) a universal framework that defines the structure and representation of processes, knowledge, and interrelationships between processes and knowledge in an enterprise;

c) means for dynamically building a model of an enterprise in real time utilising said universal framework, said model representing the enterprise as a system of interconnected processes and knowledge domains;

d) an enterprise knowledge database;

e) means for dynamically storing said model on said enterprise knowledge database; and

f) means for managing execution of processes, and managing knowledge about and contained within processes and systems of processes utilising said model in real time.

In another aspect of the system of the present invention there is provided a means for customising components of said universal framework.

In another aspect of the system of the present invention there is provided a means for visualisation and manipulation of different aspects of said framework and said model, and visual navigation means for navigating and searching through said model and said enterprise knowledge database.

The present invention is based on the discovery that knowledge management must take place in real time as an enterprise changes and evolves. Dynamically building a model in real time that replicates the system structure of the enterprise as it evolves, and then making the model available over a computer network for use in real time as enterprise members conduct their work provides the means for all members of the enterprise to understand the enterprise system and its collective knowledge. The method and system therefore enable members of an enterprise to effectively contribute to knowledge management and productivity improvement. Hence the techniques of the invention are advantageous for systemic enterprise knowledge management.

### BRIEF DESCRIPTION OF THE DRAWINGS

This invention is illustrated in the accompanying drawings, in which:

FIG. 1 depicts one embodiment of a computer-implemented architecture that can support systemic enterprise knowledge management;

FIG. 2 depicts one embodiment of a universal framework of the present invention;

FIG. 3 depicts one embodiment of rules contained in method protocols;

FIG. 4 depicts a preferred immutable process representation using a generic process cycle;

FIG. 5 depicts a process stage in the generic process cycle;

FIGS. 6A and 6B show an illustrative visualisation of the model created by the method of the present invention; and

FIG. 7 is a diagram of an illustrative embodiment of a networked computer system where the present invention may be practised.

### BEST MODE FOR CARRYING OUT THE INVENTION

Various concepts and terms are used throughout the detailed description of the invention with meanings according to the following definitions.

“Enterprise” is defined as an organisation, business, or undertaking by a collection of people, irrespective of whether the purpose is for profit or not. An enterprise may include a collaboration, or collection of organisations or businesses such as joint ventures, alliances, or partnerships. An enterprise may also be a part or subset of a larger enterprise.

“Process” is defined as connected activities or actions leading to an outcome or deliverable which may be physical or virtual. Processes may contain sub-processes, which produce intermediate deliverables on the way to completion of the parent process. Sub-processes are also known as child processes.

“Knowledge domain” is defined as all the explicit and tacit knowledge pertaining to a common knowledge theme. “Enterprise knowledge domain” is defined as all the explicit and tacit knowledge existing within an enterprise. From a systems perspective, the enterprise knowledge domain has a structure, just as the enterprise system of processes has a structure.

“Knowledge threads” are the knowledge themes representing knowledge domains. “Core enterprise knowledge threads” are all pervasive throughout an entire enterprise, and comprise the critical systemic knowledge themes for the functioning of the enterprise from a holistic perspective.

“Enterprise knowledge taxonomy” is a nomenclature based upon enterprise knowledge threads.

“Distributed datasets” are any number and type of heterogeneous dispersed collections of stored data and information of any portion of an enterprise. Distributed datasets may include distributed databases and non-electronic repositories with electronic catalogue indexes, such as libraries, paper-based repositories and computer readable media repositories.

“Enterprise knowledge database” stores all the real time data and information related to the enterprise model of the present invention, including indexes and links to data and information stored on distributed datasets throughout the enterprise.

“Systemic enterprise knowledge management” means the management of the knowledge about and contained within an enterprise by each individual and process throughout the enterprise. Systemic enterprise knowledge management may take place at different process scales within the enterprise.

“Universal framework” contains a set of components implemented as computer code required for modelling the process and knowledge structure of an enterprise viewed as an evolving system.

“Method protocols” contain rules governing interaction with, and use of, the universal framework and the enterprise model built using the method of the present invention.

“Immutable universal process representation” is a depiction of the fundamental structure of any process in an enterprise, irrespective of the scale of the process being depicted. This depiction is immutable—once created within the universal framework it is never changed. A visualisation of the representation can have a specific form or shape, such as a cyclic or linear series of contiguous stages.

The present invention takes advantage of the discovery that knowledge management must take place in real time as an enterprise changes and evolves. The invention provides a method for systemic enterprise knowledge management using a computer network through the real time construction of an enterprise model that enables universally consistent and structured capture, sharing and use of knowledge about and contained within processes and systems of processes in an intuitive manner integrated with the work practices of managers and knowledge workers. In a preferred embodiment, the present invention takes advantage of three discoveries: the discovery that processes can be represented with the same structure at any scale of detail within an enterprise; the “knowing-doing” duality of learning and the discovery that every process contains a learning cycle and any learning cycle is a process; and the discovery that core enterprise knowledge threads exist at all scales in an enterprise and can be used to interrelate processes, and hence learning cycles.

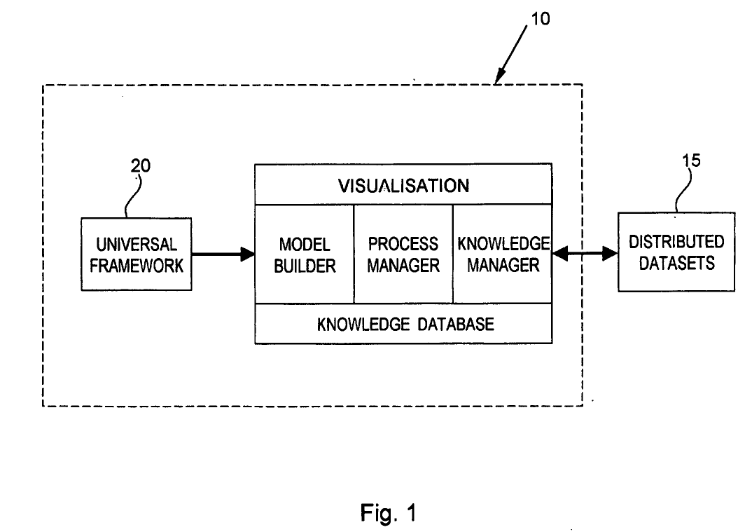

Referring to the drawings, wherein like reference numbers refer to like parts, FIG. 1 is a diagram of one embodiment of a computer-implemented architecture 10 that can support systemic enterprise knowledge management. A universal framework 20 that defines the structure and representation of processes, knowledge, and interrelationships between processes and knowledge in an enterprise is created. In a preferred embodiment framework 20 comprises components implemented as computer code. The components of framework 20 may be customised for a given enterprise.

An enterprise model is dynamically built in real time using framework 20 with the Model Builder, and therefore evolves through time as the enterprise and its processes evolve. In a preferred embodiment, a global enterprise process is created as the “seed” or “ancestral” process and included in the model for representing the highest-level system view of the enterprise. Enterprise level processes corresponding to the enterprise learning cycles for enterprise knowledge threads are also created as child processes of the global enterprise process. Whenever a new process is initiated within the enterprise, the framework and Model Builder are utilised by either a network user or an external computer program application to add the process to the model. For manual use, a visualisation of components of the framework is displayed on a network user computer using a graphical user interface. This graphical user interface is also employed for visualisation of different aspects of the model and for visual navigation and searches through the model and the enterprise knowledge database that are required by the network user when adding the new process to the model. Once created, the model and its updates are stored on the enterprise knowledge database as they occur so that the model is available for real time use over the computer network.

Use of the model may be either manual or programmatic. In the case of manual use, a network user, or group of network users, make use of the model structure whilst conducting work. In one aspect the model provides real time visual knowledge of the structure of the enterprise and the status of processes. Network users are able to manage process execution (Process Manager), and to manage knowledge about and contained within processes (Knowledge Manager), with the additional insight of how their activities fit into the enterprise. In the architecture shown in FIG. 1, Knowledge Manager allows the creation and storing on the knowledge database of knowledge links between the structure and attributes of a process, and data and information stored within distributed datasets external to the system of the present invention. Process Manager and Knowledge Manager are used in conjunction with each other, thus allowing management of the knowing-doing duality of processes. A graphical user interface is employed for visualisation and manipulation of different aspects of the model and for visual navigation and searches through the model and the enterprise knowledge database. Visualisation of the knowledge links stored on the enterprise knowledge database provides a visual index of data and information stored in distributed datasets throughout the enterprise.

Computer applications that are external to the architecture shown in FIG. 1 can make use of the model and system of the present invention. In one example, applications such as Interwoven Inc.'s Content Infrastructure suite of products can use the knowledge database to generate metadata about where web content development fits within an enterprise's business processes. In another example, workgroup or collaboration software can access the knowledge database to determine the status of related processes. In another example, a customer relationship management (CRM) system may use the knowledge database to add metadata about associations between a customer relationship process and product development processes to a native CRM dataset. In yet another example, software routines of the present invention may be used by other applications for knowledge addition to the knowledge database.

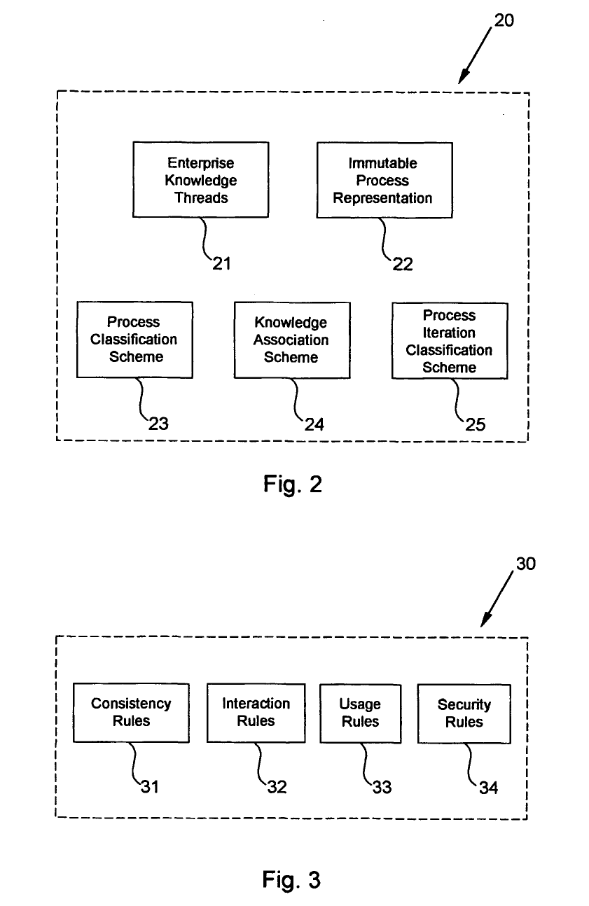

FIG. 2 illustrates an overview of a preferred embodiment of the universal framework of the present invention. In this embodiment the universal framework 20 comprises five components, and customisation constitutes tailoring variable elements of these five components to the specific requirements of a given enterprise.

The core enterprise knowledge threads 21 represent systemic knowledge domains, and also define an enterprise knowledge taxonomy. As a system, an enterprise contains core knowledge threads and corresponding knowledge domains that are critical to its performance and survival. Organisational learning therefore has to be built up from individual learning in a way that reflects these core knowledge threads. In one embodiment for a business enterprise, the enterprise knowledge threads comprise:

a) Strategic Management;

b) Business Development;

c) Asset Management;

d) Portfolio Management;

e) Finance Management;

f) Supply Management;

g) Relationship Management; and

h) Compliance Management.

In another embodiment the enterprise knowledge threads 21 may be extended to include additional knowledge threads and domains within parts of an enterprise such as various specialist knowledge domains. The method of the present invention ensures that the interrelationships of the additional knowledge threads with the enterprise knowledge threads will be included in the systemic management of knowledge.

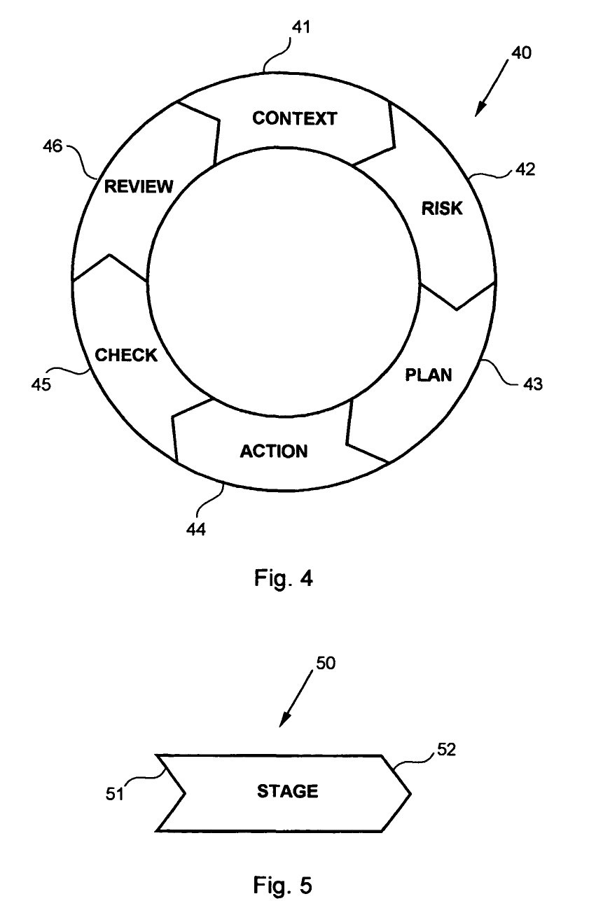

The immutable process representation 22 defines the unchangeable fundamental scalable structure of all processes within an enterprise. FIG. 4 shows a preferred immutable process representation using a generic process cycle 40. In a preferred embodiment the generic process cycle is subdivided into contiguous stages consistent with a natural teaming cycle. Individuals learn from a combination of other people and experience. An individual's knowledge is created through a never-ending iterative process. As a person learns, knowledge is built upon knowledge, refined and extended through a combination of external input, action and creative insight. Knowledge is put to use in a similar iterative fashion and is ultimately manifested in action and consequential learning. Similarly, the stages of the process cycle representation provide a means to structure activities and information of actual processes.

Take an example of crossing a road. We have learnt from childhood that the action is potentially life threatening. In order to execute the action, we go through an iterative thought process. First we check the context of the action. In this case: is the road large or small, is it busy or not, is the traffic flowing fast or slow? After checking the context of the crossing, we next assess the risks involved. How dangerous is this particular crossing compared to what we have experienced before. On the basis of this risk assessment we then plan our crossing. Will we walk fast or slow? Will we stop in the middle at a median strip? Executing the actual crossing itself implements our plan and as we are making the crossing we continually review the situation to assess whether the context is changing (such as the traffic flow increasing). The process may continue through another cycle if the context changes. Such cycles are observed everywhere that knowledge is being gained and used.

The generic process cycle 40 commences with a context stage 41. The knowledge content and activities represented by the context stage include the objectives of the process, the context in which it is initiated, and the context in which outcomes are to be delivered. The knowledge content and activities represented by risk stage 42 include risk identification and analysis for the subsequent stages of the process. The knowledge content and activities represented by plan stage 43 include all plans (also incorporating risk management plans) for the subsequent stages of the process. The knowledge content and activities represented by action stage 44 include management of the plans and execution of the tasks and sub-processes that deliver the output of the process. The knowledge content and activities represented by check stage 45 include internal quality control and checking of the outputs from the action stage 44. The knowledge content and activities represented by review stage 46 include review and measurement of the process outcomes or deliverables against the requirements and objectives of the context stage 41, thus establishing a feedback loop at the process level that contains implicit performance measures and a natural learning cycle. FIG. 5 depicts a generic process stage 50. Each process stage further comprises an input transition 51 and an output transition 52.

Returning to FIG. 2, process classification scheme 23 is used for classifying processes within an enterprise. When initiated and added to the enterprise model, each process is assigned a classification. In an illustrative embodiment the process classification scheme 23 may include a primary and secondary classification. The primary classification may be based upon process function (such as a technical field) and the secondary classification may be based upon output or product classes (both internal and external). In yet another embodiment the process classification scheme 23 may further include geographical location.

Knowledge association scheme 24 is for representing interrelationships between processes and knowledge in an enterprise. When assigned, knowledge associations link a process to the plurality of processes within knowledge threads. One can imagine a knowledge thread as a “pipeline” carrying the knowledge of the corresponding knowledge domain. A knowledge association establishes a connection between a process in a knowledge thread and the “inlet” of the pipeline of another knowledge thread in the enterprise model. Knowledge can then be “pushed” into the pipeline and “pulled” through the pipeline as required. In a preferred embodiment, the knowledge association scheme uses the core enterprise knowledge threads 21, and comprises mandatory primary and secondary associations, and additional optional associations. The primary association relates to the evolution of a process, and is defined to be the link to the knowledge thread to which its ancestors belong. The secondary association of a process relates to its purpose, and is defined to be the link to the enterprise knowledge thread to which its outcome belongs. Additional associations are defined to be links to other enterprise knowledge threads 21. A parent-child knowledge association is also included in the scheme to allow representation of the knowledge link between a process and its parent process.

Process iteration classification scheme 25 allows for repeated processes to be tracked via assignment of an iteration identifier for each new traverse of the process. The iteration classification scheme is also used when a process is stopped and restarted with a new or revised context. In an illustrative embodiment the iteration classification scheme comprises version numbers. The iteration classification scheme provides the means for tracking the learning cycle corresponding to a process. As with the example of crossing the road, each time the same process is performed, a new knowing-doing learning experience takes place and new knowledge is created. Hence, the iteration classification enables different versions of knowledge generated from the same process to be identified. Whenever a new process is initiated in the enterprise, whatever parent process it may have, it may be a repeat of a previous process, possibly with a different context. Use of the process iteration scheme 25 requires that previous versions of the process be identified prior to adding the process to the enterprise model. When the framework is used in real time, the iteration scheme therefore ensures that members of the enterprise are aware of previous enterprise knowledge for that process.

FIG. 3 depicts one embodiment of rules contained in method protocols governing the method of the present invention. Consistency rules 31 ensure consistency in various aspects of the method. For example, a process input transition 51 (FIG. 5) may only occur if the prior stage output transition is completed, and if certain input criteria are satisfied. Consistency between the input and output transitions requires that a new stage cannot commence unless all sub-processes contained within the previous stage are completed or stopped. Another example of a consistency rule is the requirement of the same primary association of a process and its ancestors. Yet another example is a consistency rule to prevent duplication of the iteration classification of a process. Interaction rules 32 are used for guiding and controlling manual or programmatic interaction with either the framework (for building the enterprise model) or the enterprise model. For example, interaction rules control the visualisation and display of components of the framework, and visualisation of certain parts of the existing model to a network user in order for that network user to add a new process to the model. In another example, interaction rules also control how the framework components can be used by computer program applications external to the system of the present invention. In yet another example, interaction rules are combined with trigger points in processes to ensure defined events are included in the model and related actions performed on the knowledge database. Usage rules 33 ensure that the method is used correctly, both manually and programmatically, and provide guidance on use of the framework and model. For example, rules on use of the framework are provided to network users when visualisations of components of the framework are displayed. In another example usage rules are included to assist a network user with the addition and retrieval within a given process stage of information from the knowledge database. In another example usage rules and consistency rules ensure process iterations are tracked correctly, and that a search is made for prior process versions before a process is added to the model. In another example, usage rules are combined with consistency rules (and, if included, trigger points and interaction rules) to control the execution, stopping and starting of processes and hierarchies of processes. In yet another example, usage rules are included for the interfacing and interaction of two or more separate enterprise models. Security rules 34 control the access of users and computer program applications to various aspects of the model and enterprise knowledge database, and include authorisations for performing various steps within the method.

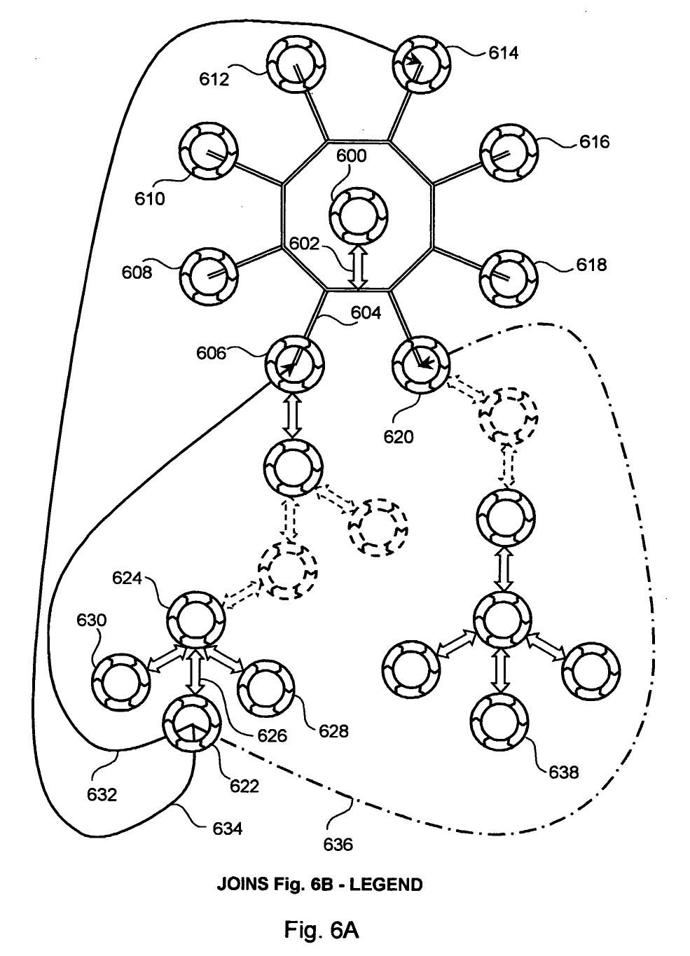

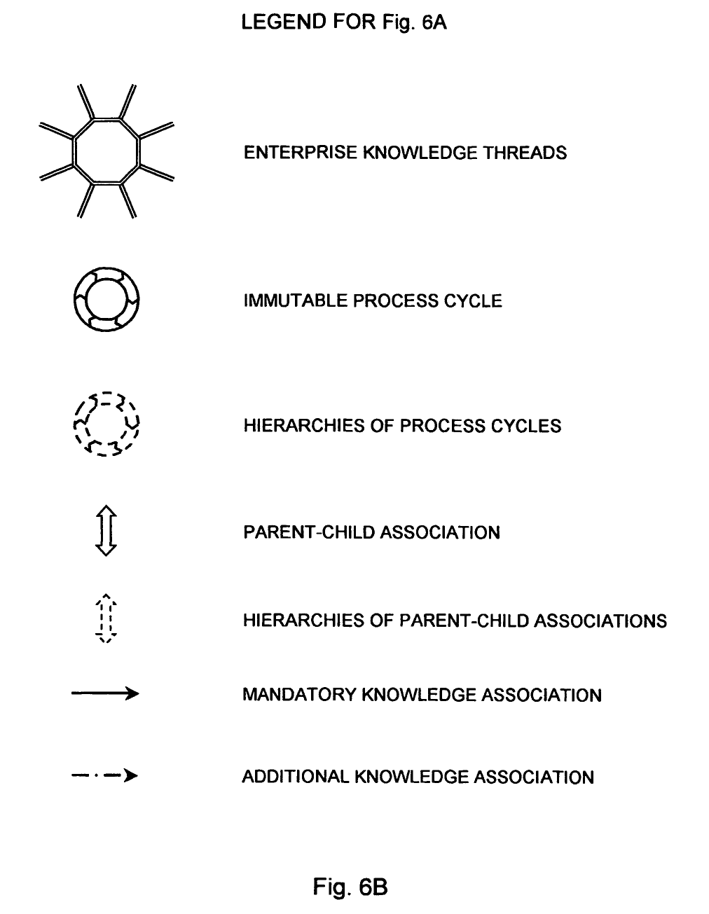

An illustrative visualisation of the model created by the method of the present invention is shown in FIGS. 6A and 6B. Referring to FIG. 6A, global enterprise process 600, which represents the entire enterprise system, has first been created along with eight enterprise knowledge threads 604 as specified in framework 20. The immutable process representation used for all processes is the generic process cycle 40 shown in FIG. 4. Eight enterprise processes have been created as child processes of global enterprise process 600 for managing the learning cycle, and activities and knowledge, of each of the respective systemic knowledge domains defined by each of the enterprise knowledge threads. Enterprise process 606 corresponds to the strategic management enterprise knowledge thread. Enterprise process 608 corresponds to the business development enterprise knowledge thread. Enterprise process 610 corresponds to the asset management enterprise knowledge thread. Enterprise process 612 corresponds to the portfolio management enterprise knowledge thread. Enterprise process 614 corresponds to the finance management enterprise knowledge thread. Enterprise process 616 corresponds to the supply management enterprise knowledge thread. Enterprise process 618 corresponds to the relationship management enterprise knowledge thread. Enterprise process 620 corresponds to the compliance management enterprise knowledge thread. Knowledge association 602 represents the parent-child relationship between the action stage of global enterprise process 600 and each of the eight enterprise processes. Hierarchies of parent-child process associations within each knowledge thread are also depicted.

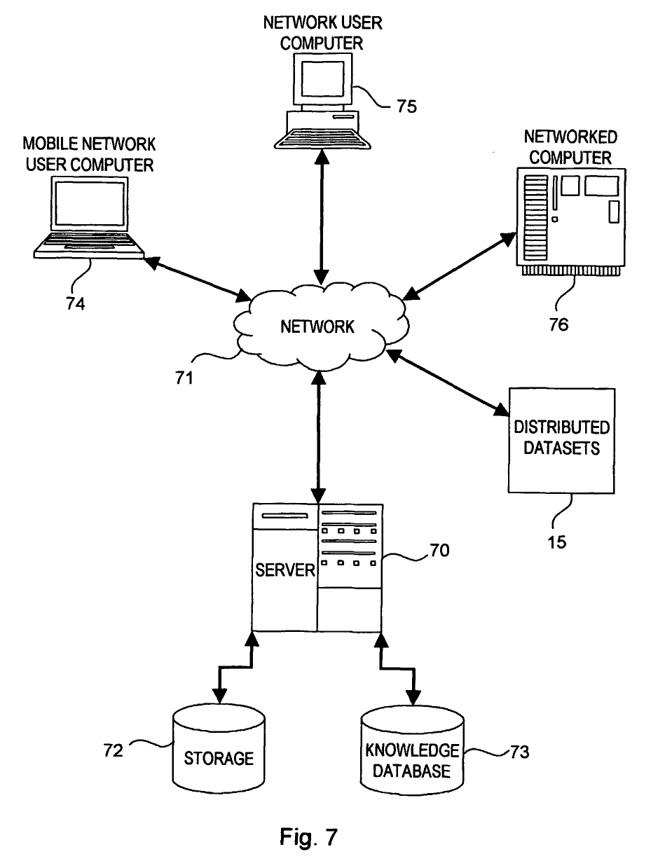

The method of building the model in real time using the universal framework and Model Builder can now be illustrated by reference to FIG. 6A. Process 622 is to be initiated and added to the enterprise model. A network user responsible for process 622 is authorised via the method protocols to add the process to the relevant stage of the parent process 624. A visualisation of components of framework 20, and of the enterprise model (as exemplified in FIG. 6A) is displayed to the network user by means of a graphical user interface. Process 622 is first associated to the specified stage of the parent process 624 using association 626. The network user next classifies and associates the process, using framework 20. When classifying process 622 a search for previous iterations of process 622 is first conducted and an iteration classification is assigned. In a preferred embodiment such a search can be conducted using a visual navigation and searching means included in the system of the present invention. In another embodiment this searching can be conducted automatically. It can be seen in FIG. 6A that ancestors of process 622 belong to the strategic management knowledge thread and therefore process 622 is assigned a mandatory primary knowledge association 632 to the strategic management knowledge thread. In this example the outcome of process 622 is assessed as being within the financial management knowledge thread, and hence process 622 is assigned mandatory secondary knowledge association 634 to the financial management knowledge thread. Further, FIG. 6A depicts an additional assigned knowledge association 636 of process 622 to the compliance management knowledge thread and all sub-processes contained within the compliance management enterprise process 620. The authorised network user has determined that the outcome of process 622 may have an influence somewhere, sometime on some compliance management activity and has judged it prudent to “push” the knowledge created in process 622 into that knowledge domain. Consistency rules 31 from the method protocols are invoked to check the classifications and associations. Once process 622 has been added to the model, the new version of the model is stored on the enterprise knowledge database 73 (FIG. 7). The same steps (possibly without visualisation) would be followed if a computer program application were responsible for adding process 622 to the model instead of a network user.

The model representation of the structure of the enterprise knowledge domain also is demonstrated in FIG. 6A. This structure is stored in the enterprise knowledge database 73. In the enterprise knowledge domain each process contains a learning cycle, and learning cycles in different knowledge threads are linked through knowledge associations. Hence there is a one-to-one correspondence in the model between the structure of the enterprise as a system of processes and the structure of the enterprise knowledge domain as a system of learning cycles. When the enterprise knowledge database is linked to data and information stored in distributed datasets within the enterprise, this one-to-one correspondence embeds the knowing-doing duality requirement for learning. The hierarchy of processes from process 622 to enterprise process 606 represents a learning hierarchy within the strategic management knowledge thread. In reality, learning that occurs at the enterprise level in process 606, is an aggregate of the learning occurring at all levels or scales within that knowledge thread. Similarly, learning occurring within one knowledge thread that influences the learning occurring in another knowledge thread is also represented in the model by means of process knowledge associations. In the particular example in FIG. 6A, learning occurring in process 622 is also included in the finance management knowledge thread through the secondary association 634, and it is included in the compliance management knowledge thread through knowledge association 636. The combination of process and learning cycle structure, the hierarchies of learning cycles, the associations between learning cycles and knowledge domains, and the links between processes and data and information creates a rich structure that provides access to both tacit and explicit knowledge within the enterprise.

Each process in an enterprise uses and generates explicit and tacit knowledge. Explicit knowledge is the knowledge that can be codified and transferred. Tacit knowledge is the knowledge that we are not necessarily aware of, but which we use to create new knowledge from our explicit knowledge. Tacit knowledge can include mental models, implicit associations of information and experience, assumptions, and capabilities upon which we base behaviours, thought patterns, or actions. In the case of an enterprise the two types of knowledge exist for a number of reasons. First, an enterprise is a “society” of knowledgeable individuals, each with their own explicit and tacit knowledge. Second, an enterprise is a complex system with these individuals interacting between themselves, and with computer programs and various apparatus. Third, the enterprise system naturally contains implicit knowledge associations and “system mental models” within its structure. Some knowledge is explicit, shared and becomes public. Some remains private or tacit knowledge of an individual, and some is tacit knowledge retained within a process or collection of processes. Interrelationships between the different elements of the enterprise system captured in the model structure as described above also generate tacit knowledge about the enterprise and its evolution. This tacit knowledge can be discovered from the enterprise knowledge database and therefore used by members of the enterprise.

Illustrative uses of the enterprise model of the present invention can now be described in conjunction with the drawings and preferred embodiments. Managers (who are responsible for processes) and knowledge workers (who are performing work within the processes) are both integral to the processes and capable of modifying the processes by their thoughts and actions—they are at the same time both a part of the enterprise system and able to modify the enterprise system. Similarly in one aspect the model is an integral part of the enterprise because enterprise members and computer applications use the model as they execute processes, and manage information and knowledge. In a second aspect the model is an evolving representation of the enterprise as a system of interconnected processes and knowledge domains, and changes over time as the enterprise changes. Consequently the enterprise knowledge domain simultaneously contains knowledge about and contained within the system of processes making up the enterprise. This fact allows new and powerful measures and insights of knowledge management performance and for the management and evolution of the enterprise from a systems perspective. The enterprise model and the corresponding knowledge database of this invention establish a means for interfacing the enterprise knowledge domain to actions in the real world.

In a preferred embodiment the relationship between action and knowledge is captured in the method of the present invention by linking process and model attributes stored on the enterprise knowledge database to data and information stored in distributed datasets throughout the enterprise. For each process stage 50 within a process, the enterprise knowledge database contains all the attributes of that stage and the process to which it belongs, as well as a list of knowledge links to data and information in distributed datasets that is relevant to that stage. These links are added in real time as work is conducted within a particular stage. The stage representation stored on the enterprise knowledge database can therefore be viewed as a “virtual container” for knowledge. Examples of the information or datasets linked to this virtual container include data and information used during the process stage; intermediate data, information and results generated during the stage; communications conducted during the stage; decisions made during the stage; and outputs of the stage. The enterprise knowledge database may also contain transaction data about when and why a knowledge link was created. Each link also contains sufficient information on how to access the relevant dataset and essential data about that dataset.

Managing process execution using the model of the present invention differs from other process or workflow management methods in three principal ways. First, process management is based upon managing a learning cycle rather than managing activity workflows. Second, every process is structured according to the immutable universal representation and thus every process in the system of processes must progress temporally through an identical series of stages. Third, the manner in which every process fits within the system of processes is known, ensuring that control of each process does not take place in isolation, but in a manner consistent with the control of the system of processes. In a preferred embodiment, execution of each process comprises moving sequentially through the stages represented by generic process cycle 40. Control of the actual real world process occurs using Process Manager according to method protocols, such as consistency rules 31 and usage rules 33, and thus corresponding control takes place for the learning cycle in the knowledge domain. Real time interaction between the activities within a process and the enterprise data and information related to that process is enforced by the method to ensure the data and information are always related to context, purpose and action. Work is conducted in a process within a particular stage. Information about the stage stored on the enterprise knowledge database defines a common environment for all members of an enterprise associated with that stage, including how the stage and process fit within the enterprise.

An advantageous use of the model for managing process execution can be demonstrated with an example of a multi-functional distributed team. Often such teams are established to work on a project that spans organisational boundaries (internal or external). With the method of the present invention, all team members will work within a common environment as dictated by the model. This environment is specific to the process (project) and not related to organisation structure or individual functional environments. Each project process stage in process cycle 40 provides team members with an identical interface and access point into the enterprise model and enterprise knowledge domain. They all work within a known context (which provides focus for the team), and all have the same enterprise knowledge interrelationships from a system perspective (including knowledge associations and enterprise knowledge threads). However, the team members can work in a totally flexible spider web of interactions and use a variety of external computer applications. All their activities and the information and knowledge generated are “linked” with the common process attributes of the process stage and the process itself (originally built into the model using framework 20). Progression of the project at the project scale is controlled according to the universal process cycle. Thus, at the scale of the project, a learning cycle and knowledge associations for the project are created. Sub-processes of the project process are handled and controlled in the same way, so that an embedded hierarchy of consistent learning cycles is captured, along with the associations to multiple knowledge domains (including specialised functional knowledge). An infrastructure is therefore provided to enhance team knowledge management and team learning. Explicit data and information created in a process stage of process cycle 40 is added manually or programmatically (for example by computer applications) to the enterprise's distributed datasets. Knowledge Manager enables this data and information to be “linked” with the process attributes of the process stage and the process itself as described above. Hence the enterprise knowledge database contains a structured index of the content of the enterprise's distributed datasets. Further, any data and information (including communications such as emails or teleconferencing) generated or imported in any given process stage is automatically turned into a combination of explicit and tacit knowledge because it is provided with additional attributes from the model such as context, purpose and relationship to action within the learning cycle and within the enterprise system—it is no longer information in isolation. Network users can retrieve data and information from the enterprise's distributed datasets using native computer applications (for example document management systems) within the context of a process stage, and the context of the process itself. Knowledge Manager of the present invention enables flexible retrieval of information from the enterprise knowledge database. Combining both computer applications and Knowledge Manager therefore enables the retrieval of both explicit knowledge and tacit knowledge. When data or information is retrieved from the distributed datasets into a new process stage it acquires the additional attributes of that process. That is, it acquires a new learning context and new associations (which may be as simple as a new iteration classification). These new attributes are added to the retrieved data and information when the links from the new process stage are stored in the enterprise knowledge database. Consequently, when the stage and learning cycle of that new process are completed, new knowledge about the original data and information (such as its use in a new context) will have been created, captured and stored.

In another aspect of the invention the enterprise model is used for managing searches of the enterprise's distributed datasets. Knowledge Manager allows various search criteria of the enterprise knowledge database to be created, for example using the model structure, stage and process attributes, and knowledge links. Navigation and search through the enterprise knowledge database therefore provides a means for contextual and structured search of the enterprise's distributed datasets. Conversely, the enterprise's distributed datasets may be searched for data and information using native applications. Once found, Knowledge Manager can then be used to understand attributes of that data and information from the enterprise, process or model perspective.

The combinations of the model structure and knowledge addition to and retrieval from the enterprise's distributed datasets enable automatic feedback loops for members of an enterprise. In reality there are many different types of feedback loops in existence within an enterprise. The “knowing-doing” or “process-learning cycle” dualities are themselves feedback loops. There are real time and post facto feedback loops, explicit and tacit feedback loops, and inter-domain feedback loops between different knowledge domains. The present invention provides the means to both use and manage such feedback loops. This can be demonstrated in the following examples with reference to FIG. 6A.

Process 622 contains a feedback loop between its context stage and its review stage, which is made available through association 626 to the stage in which it was initiated in parent process 624. Hence, once the workers in process 622 have completed that process, workers in parent process 624 are able to use the feedback to make decisions within their own activities, or to restart process 622. A real time feedback loop will also exist between process 622 and its parent process 624. At the same time, association 634 provides a means for a real time feedback loop between process 622, and other processes in the finance knowledge thread. Communications may be captured in these feedback loops within respective process stages by storing them in the enterprise's distributed datasets and linking them to the relevant process stage in the enterprise knowledge database.

Sometimes, the consequences of actions and decisions within a process may take a very long time to appear (relative to the life of the process). In that case, it is highly likely that the process would have been completed and workers would have moved on to other activities. For example, the effects of a finance strategy developed as the output from process 622 may take a number of years to appear. In the method of the present invention (unlike other knowledge management methods) a review of the effect of the finance strategy years after it was created would be part of an active process and learning cycle (for example process 614), which would have traceable associations back to the originating process 622 and its learning cycle. A feedback loop would then be established back to the original knowledge contained in process 622. A number of actions could follow from such a feedback loop. If the original workers were still in the organisation, they may be included in the review. If the knowledge in and about process 622 stored in the knowledge database and the enterprise's distributed datasets was sufficient to complete the review than the model and knowledge database would reflect its successful closure. If process 622 needed to be repeated (albeit with a different context and new parent) than the model would be updated (process 622 would be assigned a new iteration classification from the iteration classification scheme 25) and the knowledge database would reflect the new associations and the new knowledge created in process 622, the new parent, and the review stage of process 614.

In a personal feedback example, an enterprise member who has worked on a process at some previous time may wish to proactively understand the consequences of their actions and decisions from that process. In the present invention this is possible because of the learning hierarchies contained within the model structure and the enterprise knowledge database. The enterprise member is able to take advantage of the structural attributes of the model to manage a temporal search through the enterprise knowledge database, and therefore through the enterprise's distributed datasets (by virtue of the knowledge links contained in the enterprise knowledge database) using combinations of process relatives, process/learning cycle hierarchies, knowledge associations, enterprise knowledge threads, and specialised knowledge threads.

Known knowledge management methods commonly use reviews to build lessons learned databases that can then be made available for future use as best practice benchmarks or as templates. The present invention facilitates a far richer organisation of knowledge. In the present invention each process (or learning cycle) has an identical structure so knowledge domains can be created from the threads defined by that structure. If we call these “process knowledge threads”, in a preferred embodiment the generic process cycle 40 will define six process knowledge threads, which exist enterprise-wide. A process knowledge thread for review stages 46 can contain as a subset a domain of lessons learned within the processes in an enterprise. However, the lessons learned component of the knowledge generated using the present invention has a distinctly different character to known lessons learned methodologies—it is explicitly linked with the structure of the enterprise model. In the present invention reviews take place in real time at each scale, thus ensuring contextual consistency and an embedded hierarchy of reviews at all scales. A review knowledge thread is linked to enterprise knowledge threads by virtue of the knowledge associations. Lessons learned subsets with common process attributes are built from whole process cycles. Process knowledge as it evolved (rather than post facto) is accessible as well as the review knowledge. Differences in review knowledge between different iterations of a process are available for analysis. Tacit knowledge contained within the system that may be relevant to the review stage is available.

In the present invention each process knowledge thread can be combined with enterprise knowledge threads and specialised knowledge threads to generate a variety of knowledge subsets. The following list illustrates the correspondence between the explicit knowledge that is contained within process knowledge domains of the present invention and some known common management tools and techniques. It is readily apparent that combining the known tools and techniques does not reproduce the advantages of the present invention because the real time structure of the enterprise knowledge domain is neither known nor available.

a) Context Stage—strategy development and deployment methods, incentive schemes

b) Risk Stage—risk databases, enterprise risk management and tools

c) Plan Stage—estimation databases, planning methods and tools

d) Action Stage—best practice databases and tools, operational standards

e) Check Stage—quality control methods, quality assurance methods, standards databases

f) Review Stage—lessons learned databases, story telling, measurement tools

An example use of the model for tacit knowledge discovery and retrieval is provided as follows with reference to FIG. 6A. Enterprise members working within a stage of process 638, which belongs to the compliance management knowledge thread, search the enterprise knowledge database to find certain strategic management processes that have been associated with the compliance management knowledge thread. The results of this search include process 622. Further restrictions of the search criteria leave process 622 as the only process of direct interest. In this example, sibling processes of process 622 within the same stage of 624, processes 628 and 630 have not been explicitly associated with process 638. Tacit knowledge exists within the system for the members of process 638 because they are able to aggregate the knowledge of processes 622, 628 and 630 from the enterprise knowledge database and the enterprise's distributed datasets to determine, if any, the combined influence of the three processes on the work in progress in process 638. The knowledge for the members of process 638 exists not within the explicit knowledge contained within the three processes 622, 628 and 630 individually, but in the combination created by their interrelationships. In another example of tacit knowledge within the system, assume a problem has occurred within the check stage 45 of process 624. Because of the universal process structure and the knowledge associations of sub-processes of process 624, it is possible to search the enterprise knowledge database following the process knowledge threads through check and review stages of any processes having associations to process 624. The knowledge (or absence of knowledge) contained within the associated processes allows additional insight to the causes of the problem in process 624. Yet another example of tacit knowledge retrieval is the comparison of different versions of knowledge within a process held in the enterprise's distributed datasets occurring as a result of multiple iterations of that process.

FIG. 7 is an illustrative embodiment of a networked computer system where the present invention may be practised. The number and type of computers is only exemplary. A server computer 70 is connected via a network 71 to a plurality of network users having a variety of computing devices such as mobile computing devices 74, computer workstations 75, or networked computers 76 running one or more software applications. Each of these computers and the server can be standard computers programmed to interact with the network in a known manner. Server computer 70 is equipped with memory and storage 72. Server computer 70 is also connected to an enterprise knowledge database 73. Distributed datasets are also connected to the network. It will be appreciated by those skilled in the art that there are many alternative embodiments for this system. For example the server computer 70 can comprise a distributed computing system or a cluster of networked computers. The network 71 may be any form or combination of data communication networks such as local area networks (LANs), wide are networks (WANs), the Internet, Intranets or Extranets. The system is independent of the communication means connecting computers to the network or for transferring data. The plurality of network users may use any type of computing device; in particular mobile devices may include handheld computers, PDA devices, mobile phones, or laptop computers. Storage 72 may be a single device or a plurality of distributed devices. The enterprise knowledge database may comprise a distributed database or several databases. In one embodiment the enterprise knowledge database is implemented using a relational database management system such as Microsoft® SQL Server™. The distributed datasets 15 may comprise any number and type of heterogeneous datasets, including distributed databases, and may include non-electronic repositories with electronic catalogue indexes, such as libraries, paper-based repositories and computer readable media repositories. The datasets included in the distributed datasets may be implemented in a variety of alternative embodiments such as any indexing system, relational database management system, flat file or any other data storage and retrieval mechanism.

Various distributed processing technologies, for example JAVA™, may be used for implementing the software routines of the present invention in a network environment. The server computer 70 includes a universal framework 20 that defines the structure and representation of processes, knowledge, and interrelationships between processes and knowledge in an enterprise. The server computer 70 also includes software routines for:

a) customising components of said universal framework 20;

b) dynamically building a model of an enterprise in real time utilising said universal framework 20;

c) dynamically storing said model on enterprise knowledge database 73; and

d) managing execution of processes, and managing knowledge about and contained within processes and systems of processes in said enterprise utilising said model in real time.

The server computer 70 also includes software routines for including a global enterprise process as a seed process that is the ancestor of all processes initiated in the past, present and future within an enterprise in said model.

The server computer 70 and network user computers 74 and 75 include software routines for visualising and displaying components of framework 20 and aspects of said model to a network user and for visualising and manipulating aspects of said framework and said model. The server computer and network user computers also include software routines for visual navigation and searching through said model and said enterprise knowledge database. In a preferred embodiment network user computers 74 and 75 utilise Internet browsers or micro browsers.

The foregoing describes a new and useful method and system for systemic enterprise knowledge management using a computer network. Whilst the invention has been described with respect to preferred embodiments and illustrative examples, it will be understood by those skilled in the art, that numerous modifications and departures from those preferred embodiments and various changes in detail may be made therein without departing from the spirit, scope and teaching of the invention. Accordingly, the herein disclosed invention is to be limited only as specified in the following claims.

What is claimed is:

1. A method using a computer network for modelling an enterprise as an evolving system of interconnected processes and knowledge domains, comprising:
creating a universal framework that defines the structure and representation of processes, knowledge, and interrelationships between processes and knowledge in said enterprise;
dynamically building a model of said enterprise in real time utilising said universal framework, said model being initialised with at least one seed process; and
dynamically storing said model on a database;
wherein processes are added to said model in real time either manually by authorised members of the enterprise as users of said computer network or programmatically by computer program applications running on said computer network.

2. The method of claim 1 further comprising using visual means for visualising and manipulating aspects of said framework and said model, and using visual navigation means for navigating and searching through said model and said database.

3. A method for performing systemic knowledge management in an enterprise using a computer network, comprising:
creating a universal framework that defines the structure and representation of processes, knowledge, and interrelationships between processes and knowledge in said enterprise;
dynamically building a model of said enterprise in real time utilising said universal framework, said model representing said enterprise as an evolving system of interconnected processes and knowledge domains;
dynamically storing said model on an enterprise knowledge database; and
managing execution of processes, and managing knowledge about and contained within processes and systems of processes in said enterprise utilising said model in real time.

4. The method of claim 3 wherein said universal framework further includes a process classification scheme for classifying each process in said enterprise.

5. The method of claim 4 wherein said universal framework further includes an iteration classification scheme for classifying repeated or restarted processes.

6. The method of claim 3 further comprising:
creating a global enterprise process representing the highest-level system view of said enterprise, said global enterprise process being the ancestor of all processes initiated in the past, present and future within said enterprise; and
including said global enterprise process in said model.

7. The method of claim 3 further comprising using visual means for visualising and manipulating aspects of said framework and said model and using visual navigation means for navigating and searching through said model and said enterprise knowledge database.

8. The methods of claims 3 to 7 wherein said universal framework includes:
core enterprise knowledge threads for representing systemic knowledge domains;
an immutable universal process representation for representing the fundamental structure of all processes in an enterprise; and
a knowledge association scheme for representing interrelationships between processes and knowledge in an enterprise.

9. A computer system for modelling an enterprise as an evolving system of interconnected processes and knowledge domains, comprising:
a plurality of user computing devices connected to a computer network;
a server computer coupled to the computer network, said server including:
a) memory;
b) storage; and
c) a universal framework that defines the structure and representation of processes, knowledge, and interrelationships between processes and knowledge in an enterprise;
means for dynamically building a model of said enterprise in real time utilising said universal framework;
a database; and
means for dynamically storing said model on said database.

10. The system of claim 9 further comprising means for customising components of said universal framework.

11. The systems of claims 9 and 10 further comprising means for visualising and manipulating aspects of said framework and said model, and visual navigation means for navigating and searching through said model and said database.

12. A knowledge management system for enabling systemic knowledge management in an enterprise comprising:
a plurality of user computing devices connected to a computer network;
a server computer coupled to the computer network, said server including:
a) memory;
b) storage; and
c) a universal framework that defines the structure and representation of processes, knowledge, and interrelationships between processes and knowledge in an enterprise;
means for dynamically building a model of said enterprise in real time utilising said universal framework, said model representing said enterprise as an evolving system of interconnected processes and knowledge domains;
an enterprise knowledge database;
means for dynamically storing said model on said enterprise knowledge database; and
means for managing execution of processes, and managing knowledge about and contained within processes and systems of processes in said enterprise utilising said model in real time.

13. The system of claim 12 further comprising means for customising components of said universal framework.

14. The system of claim 12 further comprising means for including in said model a global enterprise process representing the highest-level system view of said enterprise, said global enterprise process being the ancestor of all processes initiated in the past, present and future within said enterprise.

15. The systems of claims 12 to 14 further comprising means for visualising and manipulating aspects of said framework and said model, and visual navigation means for navigating and searching through said model and said enterprise knowledge database.

16. A computer program product having a computer readable medium having computer program logic recorded thereon for use with a computer network for modelling an enterprise as an evolving system of interconnected processes and knowledge domains, comprising:
a universal framework that defines the structure and representation of processes, knowledge, and interrelationships between processes and knowledge in an enterprise; computer readable means for dynamically building a model of said enterprise in real time utilising said universal framework; and
computer readable means for dynamically storing said model on a database.

17. The computer program product of claim 16 further comprising computer readable means for customising components of said universal framework.

18. The computer program products of claims 16 and 17 further comprising computer read means [symbol] for visualising and manipulating aspects of said framework and said model, and computer [symbol] navigation means for navigating and searching through said model and said database.

19. A computer program product having a computer readable medium having computer program logic recorded thereon for enabling systemic knowledge management in an enterprise using a computer network, comprising:
a universal framework that defines the structure and representation of processes, knowledge, and interrelationships between processes and knowledge in an enterprise;
computer readable means for dynamically building a model of said enterprise in real time utilising said universal framework, said model representing said enterprise as an evolving system of interconnected processes and knowledge domains;
computer readable means for dynamically storing said model on an enterprise knowledge database; and
computer readable means for managing execution of processes, and managing knowledge about and contained within processes and systems of processes in said enterprise utilising said model in real time.

20. The computer program product of claim 19 further comprising computer readable means for customising components of said universal framework.

21. The computer program product of claim 19 further comprising computer readable means for including in said model a global enterprise process representing the highest-level system view of said enterprise, said global enterprise process being the ancestor of all processes initiated in the past, present and future within said enterprise.

22. The computer program products of claims 19 to 21 further comprising computer readable means for visualising and manipulating aspects of said framework and said model, and computer readable visual navigation means for navigating and searching through said model and said enterprise knowledge database.
